(19) United States
(12) Patent Application Publication
(10) Pub. No.: US 2007/0115501 A1
(43) Pub. Date: May 24, 2007

(54) Vocal status reporting system

(75) Inventors: Amanda K. Bridges, Winchester, KY (US); William J. G. Flowers, Lexington, KY (US); Charles E. Grieshaber, Versailles, KY (US); Chad E. McQuillen, Lexington, KY (US); Michael R. Timperman, Versailles, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/286,931

(22) Filed: Nov. 23, 2005

(51) Int. Cl. G06F 3/12

(52) U.S. Cl. 358/1.15; 358/1.14

(57) ABSTRACT

A method for communicating a status report from a print device having a modem to a user's telephone device including storing a message in a storage medium associated with the print device and, upon the occurrence of an event, sending the message from the print device to the user's telephone device using the modem.

### TECHNICAL FIELD

The vocal status reporting system relates to a method and apparatus for issuing status reports and, more particularly, a method and apparatus for issuing vocal status reports over a telephone line.

### BACKGROUND

Print devices such as all-in-one print devices (AIOs) and multi-function peripherals (MFPs) have become commonplace in the business office setting. Such print devices typically provide printing, copying, scanning and/or facsimile capabilities in a single unit. A typical AIO may integrate two basic components: a document scanner and a print engine. Printing and scanning may each be carried out utilizing just one component of the device (i.e., the scanner or the print engine), while copying may be performed utilizing both components (i.e., the scanner and the print engine).

Modem print devices are capable of printing high quality images at increased printing speed. As print devices continue to become more advanced, many different users may share a single print device in a business office setting.

As more and more users share a single device, workflow handling and job priority becomes a concern. Most print devices are limited to processing a single job (or a limited number of jobs) at a time. Therefore, as various users submit various jobs to a single device, the device must prioritize each job and process the jobs in turn.

Accordingly, print devices have been provided with various job handling and prioritizing programs capable of prioritize jobs based on the type of user, the type of job, the size of a job or the like. Thus, a user may submit a print job and, based on the priority of the print job, the print job may be immediately processed or stored within the job queue until the device is ready to process the print job.

Prior art print devices typically provided users with various means for monitoring the status of a job. For example, job status may be reported at the operator panel or user interface of the print device. In another example, the print device may send the user an e-mail when the user's job is complete or an error occurs. However, the prior art methods for monitoring job status have numerous disadvantages.

Accordingly, there is a need for a method and apparatus for issuing vocal status reports over a telephone line.

### SUMMARY

In one aspect, the vocal status reporting system provides a method for communicating a status report from a print device having a modem to a user's telephone device including storing a message in a storage medium associated with the print device and, upon the occurrence of an event, sending the message from the print device to the user's telephone device using the modem.

In another aspect, the vocal status reporting system provides a method for communicating a vocal status report from a print device to a user's telephone device, wherein the user's telephone device has a telephone number associated therewith. The method includes storing the vocal status report in a storage medium associated with the print device, dialing the telephone number to establish a communication line between the print device and the user's telephone device and sending the vocal status report from the print device to the user's telephone device over the communication line.

In another aspect, the vocal status reporting system provides a print device including a storage medium having at least one voice message stored therein and a facsimile subsystem having a facsimile modem associated therewith, wherein the facsimile modem is adapted to communicate the voice message from the print device to a user's telephone device.

Other aspects of the vocal status reporting system will become apparent from the following description, the accompanying drawings and the appended claims.

### BRIEF DESCRIPTION OF THE DRAWINGS

FIG. 1 is block diagram of a first aspect of the vocal status reporting system; and

FIG. 2 is a flow diagram according to a second aspect of the vocal status reporting system.

### DETAILED DESCRIPTION

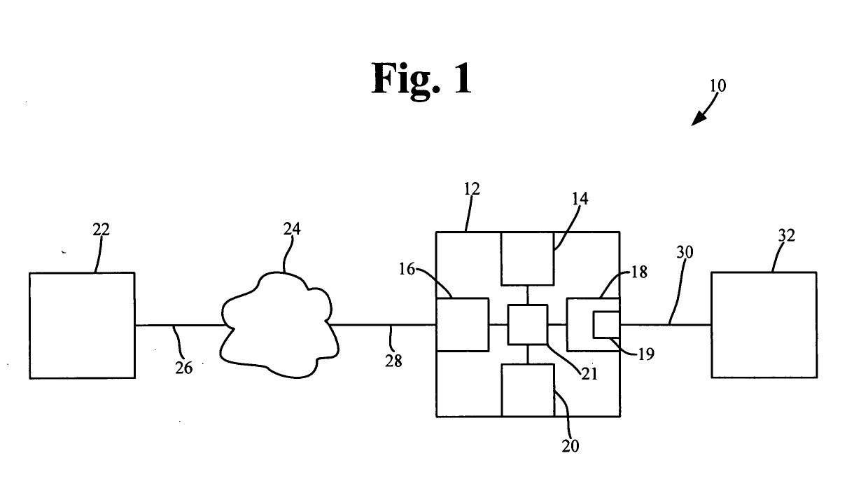

As shown in FIG. 1, a first aspect of the vocal status reporting system, generally designated 10, may include a print device 12 having a user interface 14, a network connection 16, a facsimile subsystem 18, a storage medium 20 and a processor 21. The facsimile subsystem 18 may include a facsimile modem 19.

The storage medium 20 may include one or more pre-recorded voice clips stored therein. The pre-recorded voice clips may be in various languages. For example, the storage medium 20 may include the following pre-recorded voice clips: “Your print job is complete,” “A printing error has occurred” or “Device X has begun processing your job.” Alternatively, the storage medium 20 may include one or more pre-recorded voice clips and/or text reading software or text reading capabilities. The text reading software may allow the device 12 to generate customized vocal status reports by reading names, page numbers, page counts, file names, user names and the like. For example, the text reading software may be adapted to generate customized vocal status reports (or voice messages) such as, for example, “Christine, your 19-page print job regarding file number 2004-0599.02 has been printed on device number A-3.”

A user workstation 22 may be in communication with the print device 12 over a network 24 via communication lines 26, 28 and the network connection 16. The user workstation 22 may be a computer, a handheld device such as a PDA or other device capable of communicating with the print device 12. In one aspect, the communication lines 26, 28 may be hard-wired communication lines. In another aspect, one or both communication lines 26, 28 may be wireless and the network connection 16 may be a wireless communication receiver or port. The network 24 may be the internet, or may be a private network or LAN or WAN. It is within the scope of the system 10 to employ any form of transmission of information between the print device 16 and the workstation 22 by electrical, electro-optical or electronic means.

The print device 12 may be any device capable of receiving and processing a print job. In one aspect, the print device 12 may be an AIO or MFP having scanning, copying, printing and/or faxing capabilities.

The facsimile modem 19 of the facsimile subsystem 18 may be connected to a telephone line 30 such that the print device 12 may communicate with one or more telephone devices 32 over the telephone line 30. The telephone device 32 may be any well-known telephone device. In one aspect, the telephone device 32 may be a typical land line telephone, such as a public switched telephone network (PSTN). In another aspect, the telephone device 32 may be a cellular or wireless telephone and the telephone line 30 may be wireless.

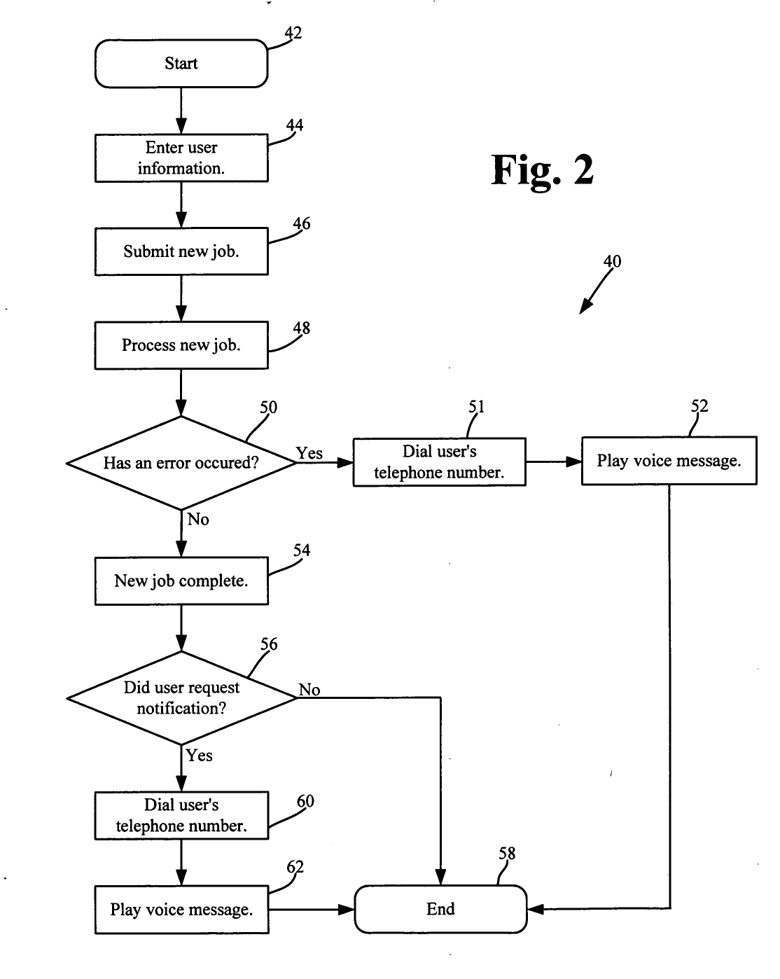

Accordingly, as shown in the flow chart of FIG. 2, in the process of the vocal status reporting system, generally designated 40, a user may initiate a new job, as shown at box 42, by entering user information at the workstation 22 (FIG. 1), as indicated at box 44. The user information entered at the workstation 22 may be communicated to the print device 12 over the network 24 by way of the communication lines 26, 28 and the network connection 16. Alternatively, the user information may be entered directly at the print device 12 using the user interface 14. At this point it should be understood that a job (i.e., a print job, a scan job, a copy job, a facsimile job or the like) may be initiated from a workstation (e.g., from the user's computer), directly at the print device 12 using the user interface 14 of the device 12 or by any other method capable of communicating a job request to the print device 12.

The user information may be the name of the user, a user identification number and/or the user's telephone number. As will be discussed, such user information may also include whether the user wishes to be notified if a process error has occurred, the job in question is complete, or upon the occurrence of some other event. In one aspect, the device 12 and/or the workstation 22 may include a database of user information such that the device 12 and/or workstation 22 may look up various types of information (e.g., telephone numbers) based upon information provided by the user.

Once a user has submitted user information, the user may initiate a new job request, as shown at box 46, and the device 12 may proceed to process the new job, as shown at box 48. The job may be any type of job capable of being processed by the print device 12. For example, the job may be a print job, a copy job, a scan job, facsimile job, a photo-printing job or the like.

As shown at boxes 50, 51 and 52, the device 12 may continue processing the job unless an error occurs. If an error occurs, the processor 21 may cause the device 12 to notify the user of the error by dialing the user's telephone number using the device's facsimile modem, as shown at box 51, and playing a voice message, as shown at box 52. The job may end when an error occurs, as shown at box 58. The voice message may be a pre-recorded voice clip stored in the storage medium 20 and retrieved by the processor 21 (e.g., “An error has occurred”) or a customized voice message delivered using text reading software (e.g., “Christine, an error has occurred while processing your request. Nine out of ten pages have been successfully printed”).

If no errors occur, the job is complete and the process proceed from decision diamond 50 to box 54. If the user did not request status reports (or notification) when entering information at box 44, then the process may end, as shown at box 58. However, if the user requested a status report (or multiple status reports) when entering information at box 44, then as shown in decision diamond 56 the processor 21 may cause the device 12 to notify the user of the status of the job, as shown at boxes 60 and 62, by dialing the user's telephone number using the device's facsimile modem 19, as shown at box 60, and playing a voice message, as shown at box 62. The voice message may be a pre-recorded voice clip selected from voice files stored in storage medium 20 (e.g., “Your print job is complete”) or a customized voice message delivered using text reading software stored in storage medium 20 (e.g., “Christine, your 19-page print job regarding file number 2004-0599.02 has been completed on device number A-3”).

In one aspect, the device 12 may always send status reports to the telephone unit 32 by way of modem 19. In another aspect, the device 12 may only send status reports if the user requested status reports at the time of submitting the user information and/or the new job request, as shown at box 44.

Thus, a user may submit a job to device 12 and request vocal status reports. Once the job is initiated, completed or an error or other event occurs, the device 12 may communicate the event as a vocal status report by contacting the user's telephone unit 32 and transmitting a message indicative of the event.

In another aspect, the telephone device 32 may be a cellular phone having text messaging capabilities and device 12 may be adapted to generate and transmit text messages (rather than voice messages) to the telephone device 32.

Although the vocal status reporting system has been shown and described with respect to certain aspects, it should be understood that modifications may occur to those skilled in the art upon reading the specification and that the vocal status reporting system includes all such modifications and is limited only by the scope of the claims.

What is claimed is:

1. A method for communicating information from a print device having a modem to a user's receiving device comprising:
storing a message in a storage medium associated with said print device; and
in response to an occurrence of an event relating to operation of said print device, transmitting said message from said print device to said user's receiving device using said modem.

2. The method of claim 1 wherein said message is a voice message.

3. The method of claim 1 wherein said print device is an all-in-one print device having a facsimile subsystem.

4. The method of claim 3 wherein said modem is a facsimile modem associated with said facsimile subsystem.

5. The method of claim 1 wherein said message is a pre-recorded voice clip.

6. The method of claim 1 wherein said message is a voice message generated using text reading software.

7. The method of claim 1 wherein said user's receiving device is connected to a public switched telephone network.

8. The method of claim 1 wherein said user's receiving device is a cellular telephone.

9. The method of claim 8 wherein said message is a text message and said cellular telephone is adapted to receive said text message.

10. The method of claim 1 wherein said event is selected from the group consisting of a beginning of a print job, an end of a print job and an error in a print job.

11. The method of claim 1 wherein said transmitting step includes dialing said user's receiving device.

12. In a method for communicating a vocal status report from a print device to a user's telephone device, said user's telephone device having a telephone number associated therewith, said method comprising:
storing said vocal status report in a storage medium associated with said print device;
dialing said telephone number to establish a communication line between said print device and said user's telephone device; and
sending said vocal status report from said print device to said user's telephone device over said communication line.

13. The method of claim 12 wherein said print device is an all-in-one print device having a facsimile subsystem.

14. The method of claim 13 wherein dialing step is performed by a facsimile modem associated with said facsimile subsystem.

15. The method of claim 12 wherein said vocal status report is a pre-recorded voice clip.

16. The method of claim 12 wherein said vocal status report is generated by text reading software.

17. The method of claim 12 wherein said user's telephone device is connected to a public switched telephone network.

18. The method of claim 12 wherein said user's telephone device is a cellular or wireless telephone.

19. A print device comprising:
a storage medium having at least one voice message stored therein;
a facsimile subsystem having a facsimile modem associated therewith; and
a processor for retrieving said at least one voice message from said storage medium and causing said facsimile subsystem to transmit said at least one voice message,
wherein said facsimile modem is adapted to communicate said voice message from said print device to a user's telephone device.

20. The print device of claim 19 wherein said voice message is indicative of a state of said print device; and said processor is programmed to cause said facsimile modem to transmit said at least one message upon an occurrence of said state.
